(19) United States
(12) Patent Application Publication
(10) Pub. No.: US 2023/0035135 A1
(43) Pub. Date: Feb. 2, 2023

(54) TOOLING FIXTURE

(71) Applicant: 3M INNOVATIVE PROPERTIES COMPANY, St. Paul, MN (US)

(72) Inventors: Randall L. Alberg, Maplewood, MN (US); Michael R. Gorman, Woodbury, MN (US)

(21) Appl. No.: 17/790,530

(22) PCT Filed: Jan. 12, 2021
(86) PCT No.: PCT/IB2021/050192

§ 371 Date: Jul. 1, 2022

Related U.S. Application Data
(60) Provisional application No. 62/961,907, filed on Jan. 16, 2020.

(51) Int. Cl. B65H 20/02; A44B 18/00; B65H 37/04

(52) U.S. Cl. CPC B65H 20/02; A44B 18/0073; B65H 37/04; B65H 2301/44318; B65H 2701/1944

(57) ABSTRACT

An improved method and tooling for a pouch forming machine to attach a fastener to the bag film layers. The method and fixture in one embodiment can unwind a double wide touch and close fastening material and then split the fastener into two strips using two turning bars, invert one of the strips, bring the strips together to interlock them with a nip roller, and then insert the interlocked strip between the bag film layers.

### BACKGROUND

Frequently, a touch and close fastener needs to be applied to a horizontal fill bag in a pouch forming machine. Tooling to accomplish this task is often switched out or modified depending on the fastener. When a new fastener is developed, corresponding new tooling needs to be provided.

### SUMMARY

Often touch and close fasteners, such as hook laminates, slide lock, or zip lock fasteners are applied to the bag film in a pouch forming machine in a pre-closed condition. This necessitates winding the touch and close fastener into a roll with the fastener material in the roll in its interlocked state. The winding and subsequent unwinding can create stresses resulting in wrinkles damaging either the touch and close fastener or the bag it is applied to. What is needed is an improved method and tooling to unwind the touch and close fastener while optionally splitting the fastener into two strips, inverting one of the strips, bringing the strips together to interlock them, and then applying the interlocked strip to the bag material. The newly invented tooling accomplishes this task.

Additionally, when bag film web tension is used to feed a stack of the bag film layers and fastening strip into the heat sealers to adhere the fastening strip to the bag, the web tension can cause the hot fastener material to stretch leading to wrinkles and misaligned fastening strips. The invention uses surface driven nip rollers solve this problem when attaching fastening members to bag film material. By positively feeding the stack into the heat sealer using nip rollers, the fastener stretching is virtually eliminated and substantially perfect alignment of the interlocked fastening strip occurs after heat sealing.

Hence is one aspect the invention resides in a fastener applicator tooling fixture having: a baseplate having a first major surface opposing a second major surface and a machine direction longitudinal axis; a feed tunnel intersecting the longitudinal axis at approximately 90 degrees having a first end and a second end; a first turning bar and a second turning bar located adjacent the second end of the feed channel, the first and the second turning bars disposed in a turn bar aperture and having an included angle of approximately 90 degrees and each turning bar forming an angle with the longitudinal axis of approximately 45 degrees; an inversion guide located machine upstream from the first turning bar in the machine direction; the inversion guide having its axis substantial orthogonal to the longitudinal axis; and a pair of nip rolls located downstream from the first and the second turning bars in the machine direction; the nip rollers each having a rotation axis substantial orthogonal to the machine direction longitudinal axis.

In another aspect the invention resides in a method of placing a touch and close fastener between a first bag film layer and a second bag film layer the method having the steps of: advancing in a machine direction the first bag film layer over a first major surface of a baseplate and advancing the second film layer over a second major surface of the baseplate; advancing a first and a second strip of fastening material in a cross-machine direction to a pair of turning bars having an included angle of approximately 90 degrees with each being disposed at approximately 45 degrees to the machine direction; aligning the first and the second strips in the machine direction by wrapping the first strip around a first turning bar and wrapping the second strip around a second turning bar of the pair of turning bars; inverting the first strip by wrapping it around an inverting guide to face a plurality of hooks on the first strip towards a plurality of hooks on the second strip; stacking the first strip onto the second strip such that the plurality of hooks on each strip are in close proximity to each other; compressing the first strip into the second strip to interlock the strips forming an interlocked strip by running the stacked first and second strips through a pair of nip rollers; and inserting the interlocked strip between the first and the second bag film layers.

### BRIEF DESCRIPTION OF THE DRAWINGS

FIG. 1 is a top perspective view of the fastener applicator tooling fixture.

FIG. 2 is a side view of the fastener applicator tooling fixture.

FIG. 3 is a top perspective view of the lead in, splitting and inverting of the fastener strips in the tooling fixture.

FIG. 4 is a top perspective view of fastener splitting and joining of the strips in the tooling fixture.

FIG. 5. is a bottom perspective view of fastener splitting and then inverting one of the strips in the tooling fixture.

FIG. 6 is a top view of the fastener applicator tooling fixture showing the surface driven nip rollers.

FIG. 7 is a perspective view of the tooling fixture showing the surface driven nip rollers interlocking the touch and close fastener strips.

FIG. 8 is a top perspective view of the fastener applicator tooling fixture with a clear bag film material present and the touch and close fastener being inserted between two layers of the bag film.

FIG. 9 is an end view of a fastening material in the interlocked state such as in FIG. 8 at 9-9.

FIG. 10 is an end view of two strips of fastening material in a hook to hook relationship ready to be interlocked together such as in FIG. 8 at 10-10.

FIG. 11 is a cross section of a splitting tool that opens the touch and close fastener from its interlocked state in FIG. 9 after being applied to the bag film by the tooling fixture.

FIG. 12 is a perspective view of a splitting tool that opens the touch and close fastener from its interlocked state after being applied to the bag film by the tooling fixture.

FIG. 13 is a cross section of the splitting, turning and joining section plate taken at 13-13 in FIG. 6.

FIG. 14 is an alternate nip roller guide plate having guide rails in the nip entrance tunnel.

### DETAILED DESCRIPTION

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than or equal to about 4. 5 wt %, 4, 3. 5, 3, 2.5, 2, 1.5, 1, 0.9, 0.8, 0.7, 0.6, 0.5, 0.4, 0.3, 0.2, 0.1, 0.01, or about 0.001 wt % or less.

As used herein a “tunnel” has at least a bottom and two sides and resides beneath the first or the second major surfaces of the baseplate, the splitting, turning and joining section plate, or the nip roller guide plate. A tunnel does not require a fixed top surface and may be completed by the bag film traversing across the top surface of the plate. It may be U-shaped, rectangular, half round, half oval, or have vertical walls and rounded corners where it joins with a flat bottom. The tunnel may be a channel and have only a bottom and two sides with an open top surface with the bag film traversing across the open top surface completing the tunnel for the fastening material traveling within it or it may include an optional top. A channel as used herein is a specific type of tunnel having an open top. The tunnel may have a continuous top surface or an intermittent top surface or the bag film in use can form the top surface of the tunnel if a fixed top surface is not present.

Fastener Applicator Tooling Fixture

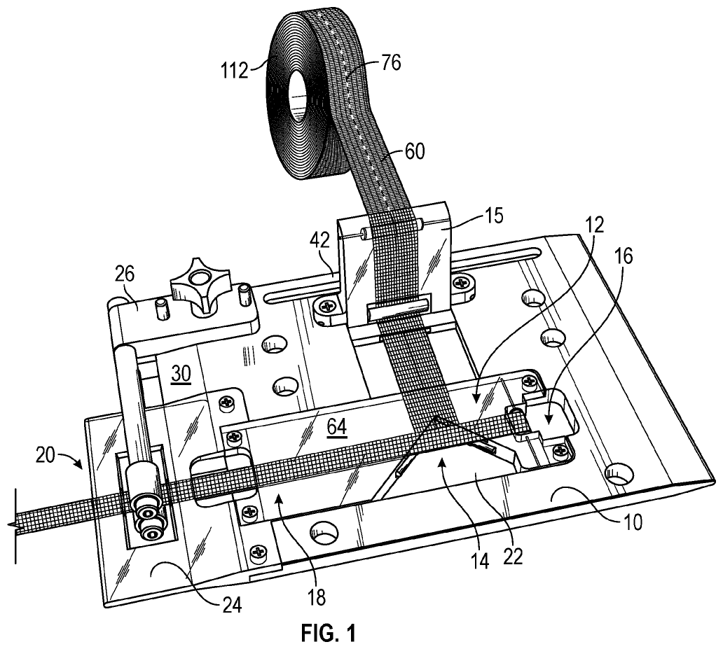

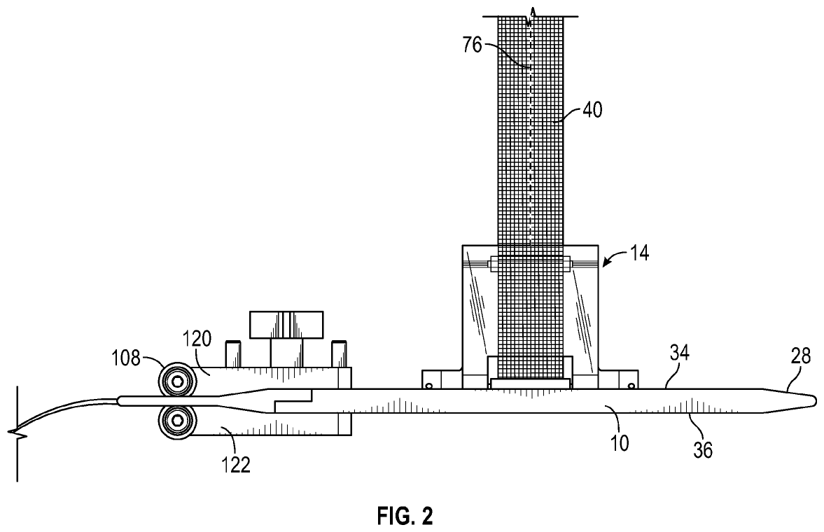

Referring to FIGS. 1 and 2, the tooling fixture includes a baseplate 10, optional lead-in rollers, a splitting section 12, a turn bar section 14, an inverting section 16, a joining section 18, and a nip roller drive section 20. The tooling fixture has four major sub-assemblies fastened to the baseplate. The lead-in s-wrap 15, the splitting, turning and joining section plate 64 located in a cut-out 22 of the baseplate, a nip roller guide plate 24, and the nip roller drive 26.

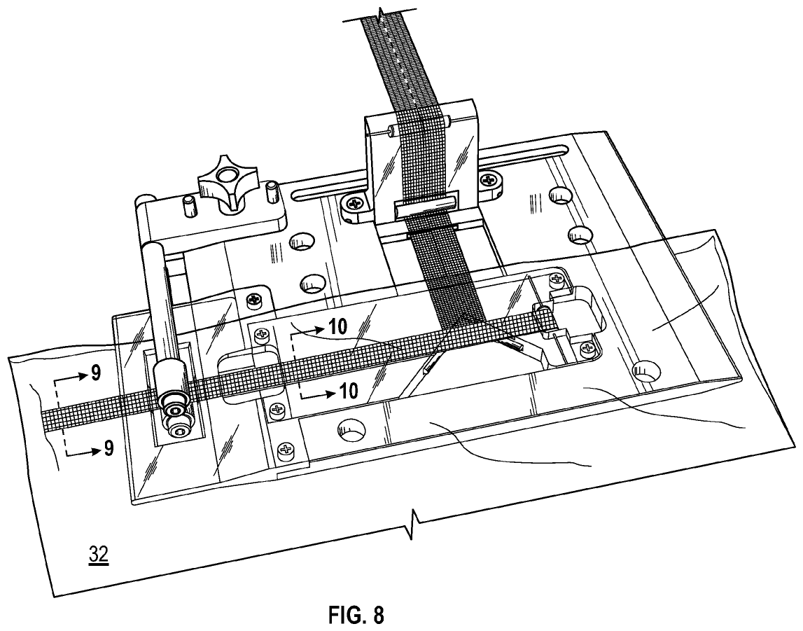

The main baseplate 10 is made of stainless steel, although other materials are suitable, and has an optional tapered leading edge 28 and an optional tapered trailing edge 30 to split and guide bag film material 32 (FIG. 8) over both the first major surface 34 and the opposing second major surface 36, which are substantially parallel to each other. The baseplate will have a suitable length, width, and thickness for the size bag being formed by the pouch forming machine. In one embodiment, the baseplate length was approximately 8 inches, the width was approximately 6 inches, and the thickness was approximately ⅜ inch. Various holes, slots, and channels are provided to either attach and position the baseplate in the pouch forming machine, attach additional sub-assemblies, or provide guiding channels for the touch and close fastening material.

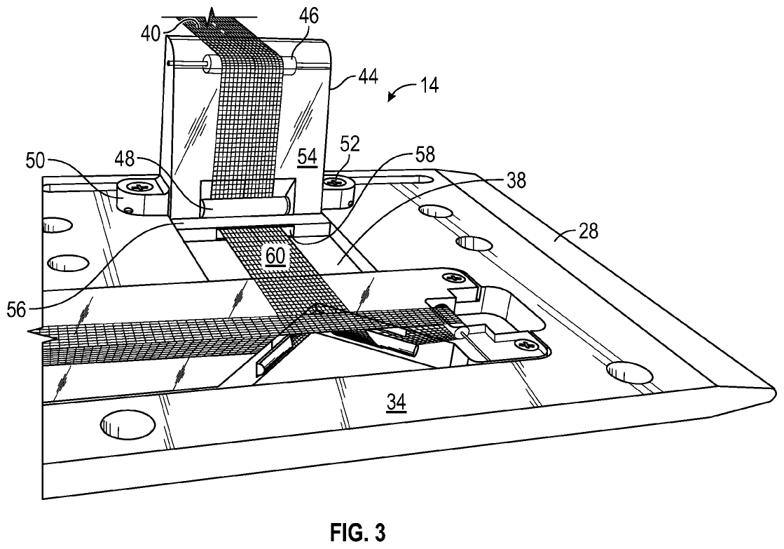

Referring to FIG. 3., in one embodiment, a cross-machine direction feed tunnel is provided to feed the fastening material to the splitting/turning section. The feed tunnel preferably has a bottom and two sides, and an open top forming a feed channel 38 and is recessed from the first major surface 34 to guide the fastener 40 beneath the bag film material traversing across the first major surface in the machine direction during use forming the top to the feed tunnel as seen in FIG. 8. An optional s-wrap section 15 is located near a first end 42 of the feed channel.

The s-wrap section 15 includes a guide frame 44 having an upper guide 46 and a lower guide 48 spaced apart vertically with their axis parallel to the longitudinal machine direction. The upper and lower guides can be rollers or fixed non-rotating guide shoes. Rollers are preferred since the guide shoes can cause more drag on the fastening material and would need frequent replacement due to wear. An attachment tab 50 extends from each lateral side of the guide frame and a fastener 49 such as a tapered head machine screw is placed through a hole in each attachment tab and is screwed into a threaded hole in the baseplate to secure the guide frame to the baseplate.

The guide frame 44 is generally L-shaped having a vertical section 54 extending above the first major surface of the baseplate that the guides are attached to and a horizontal section 56 extending below the attachment tabs 50 that locates and positions the guide frame in the machine direction within the feed channel. The horizontal section has a guide frame exit tunnel 58 through which a double wide strip 60 of fastening material 40 exits the lead-in s-wrap roller section and enters into the feed channel 38. The bottom periphery of the lower guide is located beneath the first major surface 34 of the baseplate to feed the fastener generally horizontally into the feed channel. The guide frame is made of a translucent, semi-clear plastic, but other suitable materials can be used.

The lead-in s-wrap assembly is optional depending on the location of an unwind for a roll 112 of fastening material. Alternatively, the fastening material may be fed directly into the feed channel. Alternatively, other suitable web handling equipment can be provided to guide and lead the fastening material into the feed channel.

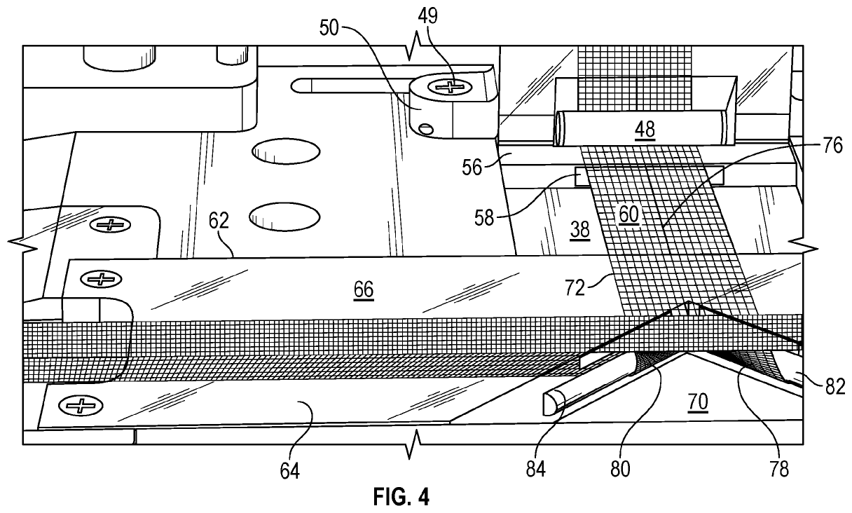

Referring to FIGS. 4, 5, and 6, the baseplate can include a central aperture 62 or slot for positioning a splitting, turning and joining section plate 64 made from a translucent, semi-clear plastic material. Other suitable materials can be used instead. Alternatively, the web handling elements mounted to the splitting, turning and joining section plate can be directly mounted on the baseplate. The baseplate has optional reduced thickness tabs adjacent to the central aperture for securing the splitting, turning and joining section plate by taper head machine screws through clearance holes in the splitting, turning and joining section plate into threaded holes in the baseplate tabs. Similarly, the splitting, turning and joining section plate has reduced thickness edges where it mates with the baseplate tabs. The thickness of the splitting, turning and joining section plate is substantially the same as the baseplate to form flush surfaces with the baseplate's first and second major surfaces.

The splitting, turning and joining section plate has a first major surface 66 substantially parallel to a second major surface 68 and a turn bar aperture 70 that is v-shaped in one embodiment. Internally located and underneath the first and second major surfaces are a plurality of guide tunnels extending in both the cross-machine direction and in the machine direction. The guide tunnels are generally rectangular in cross-section and the dimensions are adjusted to guide either a double wide strip of fastener material, a single strip of fastener material, or a vertically stacked configuration of two strips of fastener material in a touching configuration. Other suitable tunnel cross-sectional shapes can be used instead of rectangular. Alternatively, channels can be used instead of tunnels, or a combination of channels and tunnels can be used to guide the fastening material.

Suitable dimensions and clearances are used within the tunnels and channels to accommodate the various dimensional strip sizes depending on if they are double wide, single width, stacked, or interlocked. In general, tighter tolerances and clearances are preferred if the dimensional tolerances of the strip material are well controlled so as to precisely control the cross-machine position of the strips within the tooling fixture.

A double wide tunnel 72 in the cross-machine direction connects to a second end 74 of the feed channel in the baseplate. The double wide tunnel 72 feeds a double wide strip 60 of touch and close fastener that is scored or perforated in the middle of the strip forming a weakened line 76 joining a first strip 78 of fastener to a second strip 80 of fastener. The double wide strip of fastening material is fed into the double wide tunnel with the hooks facing the second major surface of the baseplate and towards the floor of the feed channel. The double wide touch and close fastener strip exits the double wide tunnel into the v-shaped aperture 70 having a first turning bar 82 and a second turning bar 84 oriented at an included angle of approximately 90 degrees to each other with each of the turning bars angled at approximately 45 degrees to the machine direction travel of the bag film material. The double wide touch and close fastener is split along the weakened line 76 in the middle of the fastener by the action of the first and second turning bars into the first strip 78 and the second strip 80. The first strip traverses around the circumference of the first turning bar and the second strip traverses around the circumference of the second turning bar. The turning bars change the orientation of the double wide strip 60 from the cross-machine direction into two single strips traveling parallel to the machine direction.

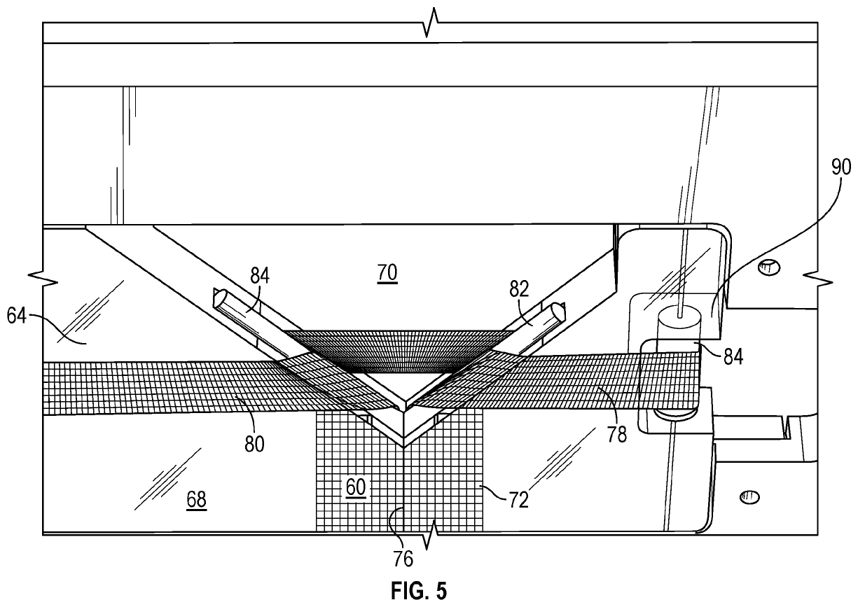

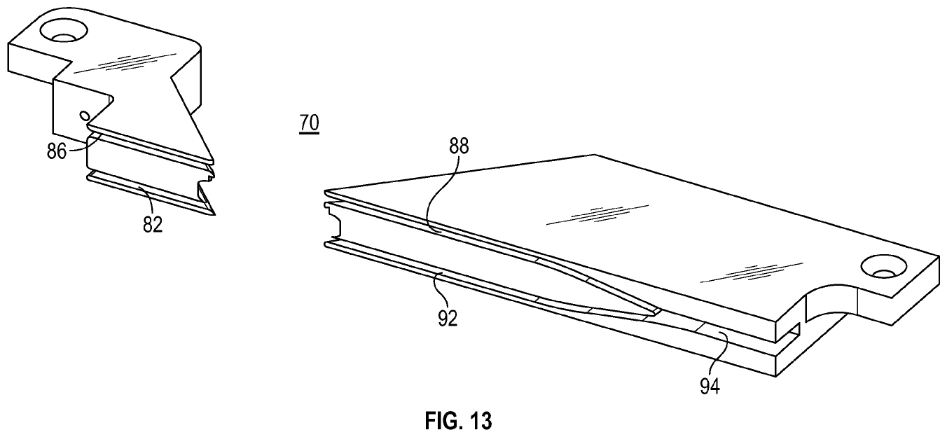

Referring to FIGS. 5 and 13, the first strip 78 is fed back upstream against the machine direction web travel of the bag film material through a lower inverting tunnel 82 to an inverting guide 84 located machine direction upstream from the turning bars, around the inverting guide, through an upper inverting tunnel 86, and back across the top of the v-shaped aperture over the turning bars and into an upper converging tunnel 88. This locates the hooks of the first strip 78 facing down towards the second major surface 68 of the splitting, turning and joining section plate. An optional first threading aperture 90 is present adjacent to the inverting guide 84 to provide access to the circumference of the inverting guide to use one's fingers to assist in feeding the first strip around the inverting guide and back into the upper inverting tunnel.

The inverting guide can be a roller or a guide shoe having its axis parallel to the cross-machine direction. A roller is preferred to reduce drag on the fastening strip and to reduce wear on the inverting guide.

The second strip 80 traverses around the circumference of the second turning bar 84 and enters a lower converging tunnel 92. This places the hooks on the second strip facing up towards the first major surface 66 of the splitting, turning and joining section plate.

The first or second turning bars can be a solid material, a hollow material, a porous material, or drilled with a central air supply duct. Air can be supplied to the drilled or porous bars to make an air turn guide bar if desired to reduce friction.

With the hooks on each strip now facing and opposing each other in their respective converging tunnels, the strips exit the converging tunnels into a stacked or double height exit tunnel 94 where the hooks on the first strip are brought into close proximity or a touching configuration with the hooks on the second strip as shown in FIG. 10.

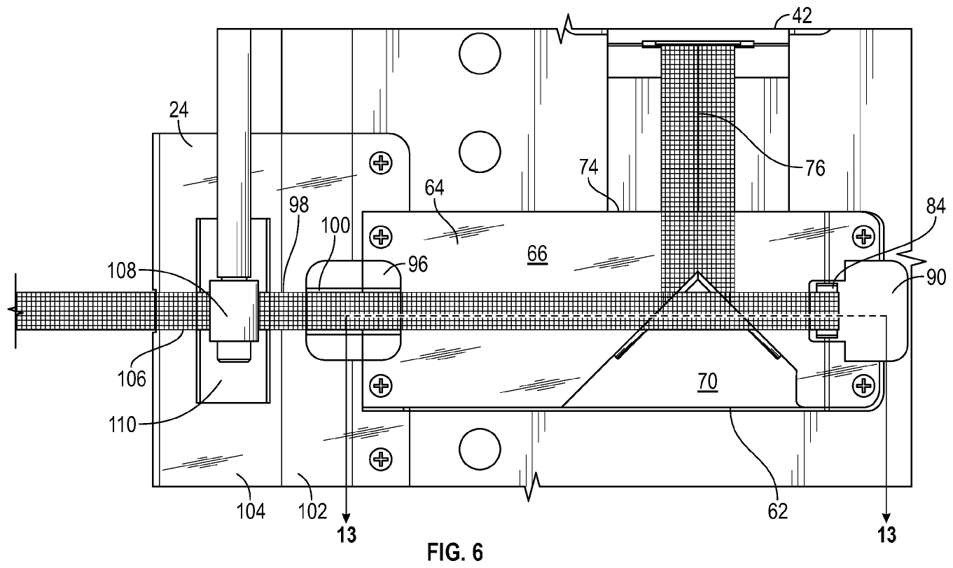

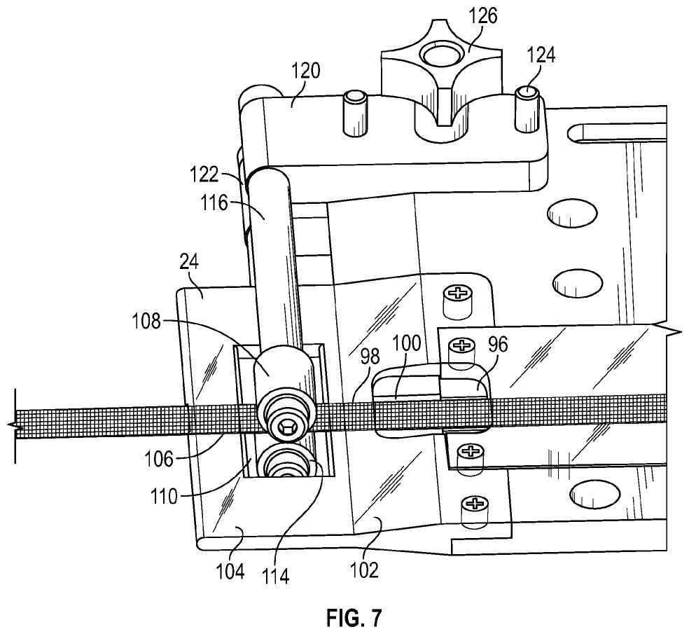

Referring now to FIGS. 6, 7, and 14, after exiting the double height exit tunnel, the strips traverse through an optional second threading aperture 96 that is provided at the end of the exit tunnel for finger access to move the stacked strips into an optional entry nip roller tunnel 98 in the optional nip roller guide plate 24. An optional machine direction channel 100 is provided within the second threading aperture to guide the strips though this space.

The nip roller guide plate 24 can be a separate piece made from a translucent, semi-clear plastic material that is also attached via tapered head machine screws to the baseplate; although, it could also be unitary and contiguous with the splitting, turning, and joining section plate or baseplate. The nip roller guide plate has an optional trailing edge taper 102 to match the baseplate and an optional flange 104 extending from the end of the trailing edge taper. The flange desirably extends all the way to the sealing section of the pouch forming machine to better control the cross-machine position of the strips. As such, the machine direction length of the flange and a nip roller exit tunnel 106 can be varied according to the specifics of the pouch forming line. Guiding the strips as close as possible all the way to the sealing bar is preferred for best alignment but is not required.

The strips exit the entry nip roller tunnel and traverse through a pair of nip rollers 108 located in an optional nip aperture 110 in the flange 104. The nip rollers compress and interlock the two strips together and are surface driven by the upper and lower bag film layers traversing across the baseplate as seen in FIG. 8. Thereafter the interlocked strips enter the optional nip exit tunnel 106 in the optional flange 104 and complete their traverse through the optional nip roller guide plate and are placed between the upper and lower bag film layers.

If desired the surface nip rollers can simply be placed after the double height exit tunnel and some or all of the features in the optional nip roller guide plate can either be eliminated or they can be individually combined in any desired combination. Including the optional nip tunnels and the nip aperture can better serve to align and guide the stacked strips prior to them being interlocked but are not necessary depending on the type of interlocking fastening material being applied. In particular, assuring the first strip 78 is parallel to the second strip 80 before and after the nip rollers can prevent stresses from developing in the interlocked strip once it is compressed together by the nip rollers. The nip entrance and exit tunnels accomplish this task and help to feed the strips substantially parallel to the bag film layers traveling in the machine direction. If the strips are not parallel when they are interlocked, they can assume a curled or wavy orientation after being interlocked.

A unique aspect of the tooling fixture is the surface driven nip rollers 108. As stated, the nip rollers are surface driven by the bag film layers traversing across the first and second major surfaces of the baseplate. This then sandwiches, compresses, and interlocks the first and second strips together and advances the interlocked strip to bring the flat backside of each strip into contact with the inner surface of the bag film for attachment in the sealing section of the bag machine. Since the nip rollers are surface driven, they will track the machine speed precisely and act to pull the fastening material through the entire tooling fixture and provides the motive force to unwind the double wide fastening material off the roll 112 in FIG. 1.

The surface driven nip rollers solve a major problem with attaching fastening members to bag film material. Namely, when only bag film web tension is used to feed the stack of bag film layers and fastening strip into the heat sealers, the web tension can cause the hot fastener strip to stretch just before or at the sealing section leading to wrinkles and misaligned fastening strips. By positively feeding the interlocked strips into the heat sealer of the pouch forming machine using nip rollers the stretching is virtually eliminated and substantially perfect alignment of the interlocked fastening strip occurs after heat sealing.

The exterior surface of each nip roller is covered by a compliant elastomeric material such as neoprene rubber. The nip rollers 108 rotate on bushings 114 that have their inner surfaces located on a cross-machine support shaft 116. Suitable bearings can be used instead. Each cross-machine shaft terminates in a locating block. The upper locating block 120 rests on the first major surface 34 of the baseplate and the lower locating block 122 rests on the second major surface 36 of the baseplate. A pair of locating pins 124 press fit into the lower locating block extends through holes in the baseplate and through holes in the upper locating block to position the nip rollers in the machine and cross-machine directions so the bag film and interlocked fastening strip traverses through the tooling fixture without steering or wrinkling either the bag film or the fastening strip. A threaded knob 126 through clearance holes in the upper locating plate and baseplate into a threaded hole in the lower locating block secures the assembly. If desired, optional gage washers can be placed between the locating blocks and the baseplate to alter/set the nip gap between the rollers.

If a fixed gap is being utilized between the nip rolls, then the gap is adjusted to be less than or equal to two thicknesses of the bag film material plus the thickness of the interlocked strip of fastening material. Thus, the interference between the gap between the nip rollers and the overall height of two thicknesses of the bag film material plus the thickness of the interlocked strip of fastening material can be from about 0.020″ to about 0.001″, about 0.015″ to about 0.001″, about 0.010″ to about 0.001″, or about 0.006″ to about 0.001″. In one embodiment, 5 thousand (0.005″) of an interference was used for the nip drive rollers for the fastening material in FIG. 10.

Rather than a fixed nip gap, one or both of the nip rollers can be located on a linear slide and a fixed nip load can be applied by a suitable force such as an air cylinder. The air cylinder(s) can be used to open the nip rollers for threading and then actuated to close the nip rollers and apply a fixed compressive force to the bag film layers and stacked fastening strip material traversing through them.

In alternative embodiments, the nip rollers can be surface driven by the bag film material or rotated by a suitable drive. A small servo drive electronically coupled to the master speed set point of the line could be used with a live power shaft to turn one or both of the nip rollers. Unless extremely thin and weak bag film is being used, the surface drive is preferred from a cost and complexity standpoint.

In alternative embodiments, the nip rollers can have a one-way clutch to allow rotation in one direction and prevent rotation is the opposite direction. The one-way clutch would allow bag film material to advance in the machine direction while preventing the bag film material from reversing direction.

In alternative embodiments, one or more fastener guide rails 128 as discussed in the next section can extend from any of the tunnel's interior surfaces to engage with the fastening material. The guide rails extend in the machine direction and can engage with the fastener material and can control its cross-machine positioning within the tooling fixture. For example, one or more machine direction guide rail segments extending from the bottom surface of the upper converging tunnel and one or more machine direction guide rail segments extending from the top surface of the lower converging tunnel can position the first strip and the second strip in proper alignment for interlocking. The cross-machine direction centerlines of the upper and lower guide rails are slightly offset to feed the strips slightly laterally offset as seen in FIG. 10 for the strips in the aligned and ready for closing orientation. The guide rails in the tooling function in a similar manner to the guide rails in the touch and close opener discussed in the next section.

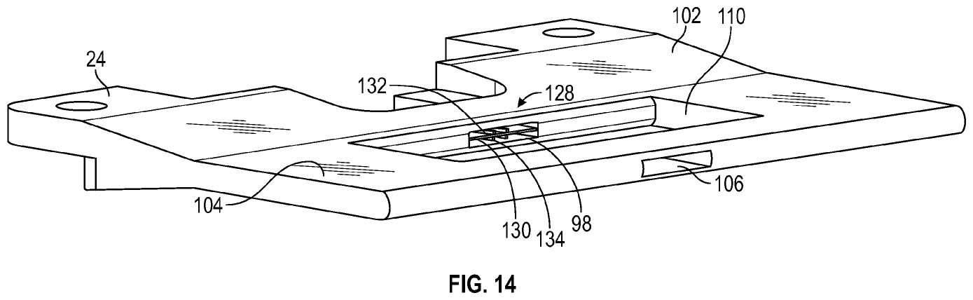

Referring now to FIG. 14, optional guide rails 128 are located in the nip entrance tunnel 98 in another embodiment of the nip roller guide plate 24. A cross-machine guide rail flange 130 is connected to the opposing sidewalls of the nip entrance tunnel at approximately the midpoint of the tunnel's height. A pair of machine direction guide rails 132 extend from the top surface of the guide rail flange and a pair of offset machine direction guide rails 134 extend from the bottom surface of the guide rail flange. The centerlines of the guide rails on the top surface are offset from the centerlines of the guide rails on the bottom surface to properly align the first and the second strips just prior to the surface driven nip rollers. Alternatively, a similar flange and guide rails can be in the double height exit tunnel 94 in addition to or instead of the flange located in the nip entry tunnel.

Instead of a double wide fastening strip with a line of weakness, two separated strips of fastening material can be fed into the tooling's feed channel. The first and the second turning bars would still orientate the separated strips properly for interlocking by the nip rollers; however, they would not act to split the fastening material into two discrete strips. Alternatively, a small slitter can be located on the tooling to either slit the double wide strip into two pieces or to add a weakening line for splitting by the action of the turning bars.

Fastener Opener

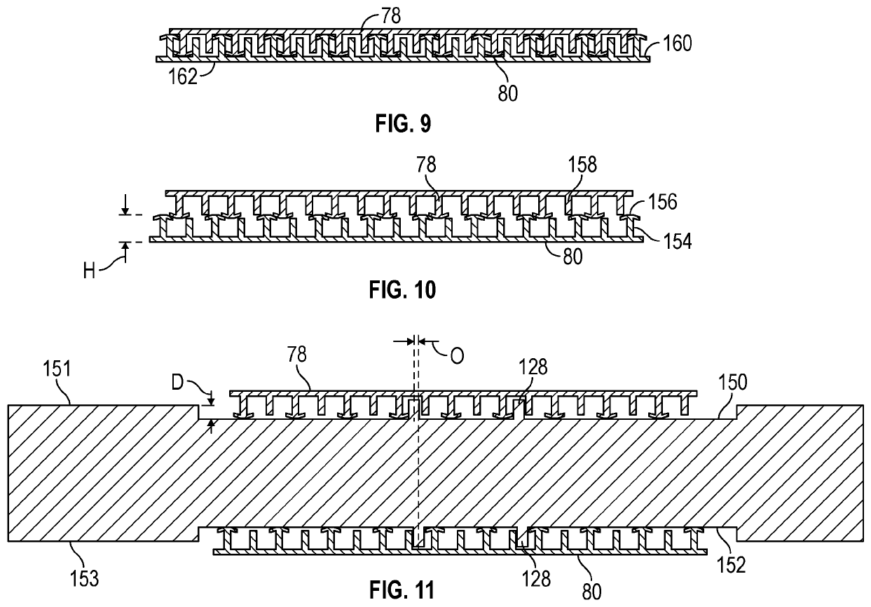

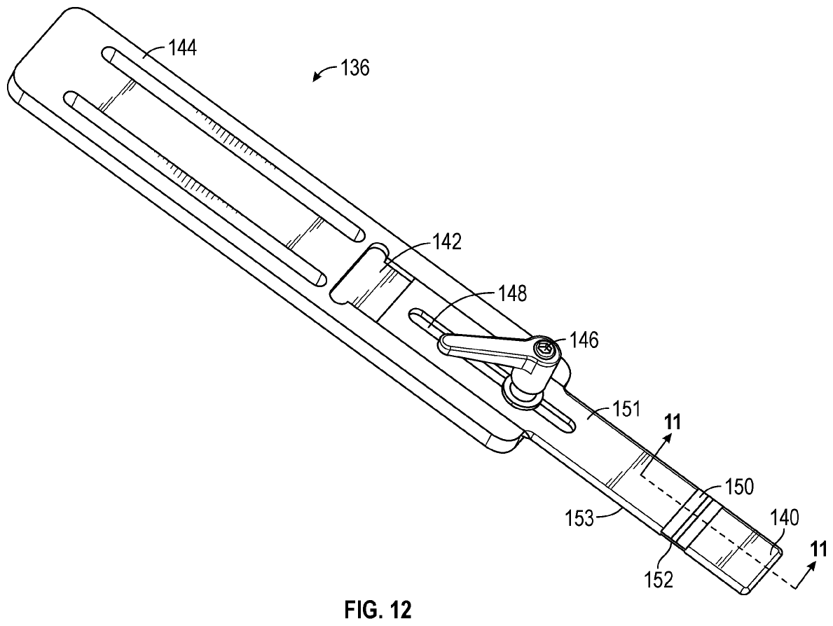

Referring now to FIGS. 11 and 12, an opener 136 for the touch and close fastener material of FIGS. 9 and 10 is shown. The opener is used to open the touch and close fastener after sealing it to the bag film layers in order to fill a gusseted pouch with its intended contents. A bottom fill pouch may not use the opener and instead leave the fastener in its interlocked state.

As seen, the opener has a thin metal blade 140 having an overall rectangular shape made from stainless steel bar stock. The edges of the blade can be radiused or chamfered to reduce snagging on the bag film material. The blade 140 fits into a cutout 142 in a holder 144 and is secured by a threaded handle 146. A slot 148 is present in the blade to adjust its cross-machine position relative to the fastening material attached to the bag film layers for proper cross-machine alignment. Milled into the surface of each side of the blade is a first guide channel 150 on a first side of the blade 151 and a second guide channel 152 on a second side of the blade 153. The guide channels extend in the machine direction and are oriented approximately 90 degrees to a longitudinal axis of the blade. The guide channels are wider than a strip of the fastening material applied to the bag film for clearance purposes.

As seen in FIGS. 9 and 10, the touch and close fastener has a plurality of rail segments 154 with caps 156 forming hooks and a plurality of posts 158 aligned in alternating rows extending from a first major surface 160 of the backing. In order to appropriately guide the touch and close fastener, the guide channels have at least one machine direction guide rail 128 extending from a bottom surface of the guide channel. The guide rails are substantially parallel to the guide channel.

In a preferred embodiment, there are two guide rails extending from the bottom surface of each guide channel. The guide rails resemble a railroad track with them spaced apart in the cross-machine direction the appropriate gage distance to engage with the fastener rail segments or posts on the touch and close fastener. In various embodiments of the invention each guide channel can have 1, 2, 3, 4, 5, 6, 7, 8, 9, or 10 or more guide rails disposed within it depending on the width of the touch and close fastening material.

The width and height of each guide rail is sized to have a small clearance when engaged with the touch and close fastener. The height of the guide rail, R, is sized to have a clearance to the first major surface 160 of the backing when the fastener cap 156 is in contact with the bottom of the guide channel. The width of the guide rail is sized to have a clearance to the side of the cap 156 and the posts 158 when the guide rail is located within the gap between the fastener hook (rail segment plus cap) and the row of adjacent posts. These clearances can be adjusted as necessary depending on the specific fastening material used and the tolerances of the fastening material.

The cross-machine direction centerline of the guide rails in the second guide channel are offset in the cross-machine direction from the centerline of the guide rails in the first guide channel by a distance O of approximately 0.003″ for the fastening material shown in FIG. 10. The offset is needed because when the touch and close fastener is interlocked, the hooks and posts of the first fastener strip are offset from the hooks and posts of the second fastener strip when they are fully engaged. The offset dimension between the centerlines of the top and bottom guide rails can be adjusted according to the geometry of the touch and close fastener material.

The distance between the guide rails within the channel can be adjusted depending on the fastening material used. In general, at least one row of either rail segments with caps (hooks) or row of posts should be between a pair or guide rails. Preferably at least 2, 3, 4, 5, 6, 7, 8, 9, or 10 rows of either hooks or posts are present between a pair of guide rails. In one embodiment, four rows are present.

The depth, D, of each guide channel is preferably less than an overall height, H, of the fastening material; although, it can be the same or more than the height of the fastening material. The reason the depth, D, is preferred to be less is that line tension on the bag film material with the applied fastener will tend to keep the caps in a slight compressive force with the bottom of each guide channel with a shorter depth thereby ensuring that the fastener will engage completely with each guide rail.

It was found that when an opener without a guide rail in the guide channels was tested it did not function nearly as well as one with the guide rails. In fact, there was a 95% failure rate for pouches with the self-closing fastener after the crushing section of the bag forming line when the pouch width in the machine direction exceeded 10 inches. After the fastener material was crushed in the area of the side seal for the side seaming operation, the pouches with side seams would not reseal due to misalignment of the fastening strips on each side of the pouch. Such a rate of failure is commercially unusable, and no manufacturer would use the fastening material of FIG. 11 for a pouch closure. Thus, the guide rails solved a major problem of keeping the opened fastening strips properly aligned when the bag film was fed into the crushing section of the pouch forming line prior to side seaming.

Fastener Material

Referring now to FIGS. 9 and 10, one embodiment of a touch and close fastener material is shown. The fastener includes a backing 162 having parallel rows of rail segments 154. The rail segments protrude perpendicularly from the first major surface 160 of the backing and have a base portion and a cap portion 156. The cap has a width that is greater than the base portion and overhangs the base portion at least on opposing sides. The fastener does not include a continuous rail, and instead has rail segments that are separated from each other on the backing.

The fastener also includes parallel rows of posts 158 extending from the backing. The posts protrude perpendicularly from the backing's first major surface and are separated from each other on the backing. In general, the fastener will have alternating rows of capped rail segments and rows of discrete posts.

The fastener is self-mating in that a first and a second strip of the fastener material with the caps facing each other will interlock when pressed together. The overhang of one cap will lock under the overhang of a facing cap. The posts reduce lateral movement of the two fastening strips and flex outward to allow the caps to pass when interlocking the two strips. Once engaged, the posts prevent the strips from shifting laterally and the caps from disengaging; however, with sufficient force applied to the strips they will unlock as the caps force themselves past each other.

More information on this and other fastening material and suitable reclosable packages using the fastening material can be found in published patent application WO 2019/102303 entitled Reclosable Package Including Self-Mating Fastener claiming priority to US patent application serial numbers 62/590,904 and 62/648,536 and in U.S. patent application Ser. No. 62/855,307 filed on May 31, 2019 entitled Reclosable Package Including Self-Mating Fastener and Process of Making Same. These patent filings are herein incorporated by reference. Other embodiments of the fasteners than the one described and illustrated here are in the referenced patent filings and include fastening materials with continuous ribs and rail segments, continuous ribs and continuous rails, and continuous ribs, rail segments, and posts.

Methods of Applying a Touch and Close Fastener to a Bag Film

As discussed, the tooling fixture can be used to insert an interlocked fastener between two layers of bag film material. Alternatively, the method can be used to apply a single strip of fastening material to a single bag film layer.

In one embodiment, the method includes advancing in the machine direction a first bag film layer over a first major surface of a baseplate and advancing in the machine direction a second bag film layer over a second major surface of the baseplate. Advancing a double wide strip of fastening material in the cross-machine direction to a pair of turning bars having an included angle of approximately 90 degrees with each being disposed at approximately 45 degrees to the machine direction. Splitting the double wide fastener into a first strip and a second strip as the fastening material traverses over the circumference of each turning bar. Wrapping the first strip around the first turning bar and wrapping the second strip around the second turning bar.

Alternatively, the method can include advancing a first strip of fastening material and a second strip of the fastening material in the cross-machine direction to a pair of turning bars having an included angle of approximately 90 degrees with each being disposed at approximately 45 degrees to the machine direction. Wrapping the first strip around the first turning bar and wrapping the second strip around the second turning bar.

Inverting the first strip by wrapping it around an inverting guide to face the hooks on the first strip towards the hooks on the second strip. Converging and/or stacking the first strip onto the second strip such that the hooks on each strip are in close proximity to each other. Compressing the first strip into the second strip to interlock the strips by running the stacked first and second strips through a pair of nip rollers. Inserting the interlocked strip between the first and the second bag film layers.

The method can further include surface driving the nip rollers by bringing them into contact with the first bag film layer and with the second bag film layer such that a stack of a first bag film layer followed by the first strip, the second strip, and the second bag film layer advances through the nip rollers.

The method can further include separating the touch and close fastener strips after heat sealing them to the bag film layers by inserting a blade between the first and the second bag film layers. The blade having a first guide channel and a first guide rail extending from a bottom surface of the first guide channel located on a first side of the blade and a second guide channel and a second guide rail extending from a bottom surface of the second guide channel located on a second side of the blade.

1. A fastener applicator tooling fixture comprising:
a baseplate having a first major surface opposing a second major surface and a machine direction longitudinal axis;
a feed tunnel intersecting the longitudinal axis at approximately 90 degrees having a first end and a second end;
a first turning bar and a second turning bar located adjacent the second end of the feed channel, the first and the second turning bars disposed in a turn bar aperture and having an included angle of approximately 90 degrees and each turning bar forming an angle with the longitudinal axis of approximately 45 degrees;
an inversion guide located upstream from the first turning bar in the machine direction; the inversion guide having its axis substantially 90 degrees to the longitudinal axis; and
a pair of nip rolls located downstream from the first and the second turning bars in the machine direction; the nip rollers each having a rotation axis substantially 90 degrees to the machine direction longitudinal axis.

2. The fastener applicator tooling fixture of claim 1 comprising a lower inverting tunnel adjacent to the first turning bar leading to the inversion guide and an upper inverting tunnel leading from the inversion guide back to the turn bar aperture.

3. The fastener applicator tooling fixture of claim 1 or 2 comprising an upper converging tunnel leading from the turn bar aperture to a stacked height exit tunnel and a lower converging tunnel leading from the turn bar aperture to the stacked high exit tunnel.

4. The fastener applicator tooling fixture of claim 1 comprising a nip roller guide plate having a nip aperture with the nip of the nip rolls located in the nip aperture.

5. The fastener applicator tooling fixture of claim 4 comprising an entry nip roller tunnel leading to the nip aperture.

6. The fastener applicator tooling fixture of claim 4 comprising a nip roller exit tunnel leading away from the nip aperture.

7. The fastener applicator tooling fixture of claim 4 comprising a trailing edge taper and a flange extending from the trailing edge.

8. An opener for an interlocked fastener comprising:
a blade having a first side, an opposing second side, and a longitudinal axis;
a first channel in the first side having a first bottom surface and a first guide rail extending from the first bottom surface; the first channel extending approximately 90 degrees to the longitudinal axis and the first guide rail parallel to the first channel;
an opposing second channel in the second side having a second bottom surface and a second guide rail extending from the second bottom surface; and the second channel extending approximately 90 degrees to the longitudinal axis and the second guide rail parallel to the second channel.

9. The opener of claim 8 wherein the first guide rail has a first centerline and the second guide rail has a second centerline and the first centerline is offset from the second centerline by a distance O.

10. The opener of claim 8 wherein the first channel has a depth D and the rail has a height R and D is greater than R.

11. The opener of claim 10 wherein the opener is used to open a fastener having an overall height H from a backing to a cap and D is less than H.

12. A method of placing a touch and close fastener between a first bag film layer and a second bag film layer the method comprising the steps of:
advancing in a machine direction the first bag film layer over a first major surface of a baseplate and advancing the second film layer over a second major surface of the baseplate;
advancing a first and a second strip of fastening material in a cross-machine direction to a pair of turning bars having an included angle of approximately 90 degrees with each being disposed at approximately 45 degrees to the machine direction;
aligning the first and the second strips in the machine direction by wrapping the first strip around a first turning bar and wrapping the second strip around a second turning bar of the pair of turning bars;
inverting the first strip by wrapping it around an inverting guide to face a plurality of hooks on the first strip towards a plurality of hooks on the second strip;
stacking the first strip onto the second strip such that the plurality of hooks on each strip are in close proximity to each other;
compressing the first strip into the second strip to interlock the strips forming an interlocked strip by running the stacked first and second strips through a pair of nip rollers; and
inserting the interlocked strip between the first and the second bag film layers.

13. The method of claim 12 comprising splitting the first and the second strip apart in a double wide strip of fastening material having a line of weakness joining the first strip to the second strip as the strips traverse across the pair of turning bars.

14. The method claim 12 comprising surface driving the nip rollers using the bag film layers to rotate them.

15. The method of claim 14 comprising feeding a stack of the first bag film layer followed by the first strip, the second strip, and the second bag film layer through the nip rollers.

16. The method of claim 12 comprising separating the first and second fastener strips after heat sealing them to the bag film layers by inserting a blade between the first and the second bag film layers; the blade having a first guide channel and a first guide rail extending from a first bottom surface of the first guide channel located on a first side of the blade and a second guide channel and a second guide rail extending from a second bottom surface of the second guide channel located on a second side of the blade.

17. The method of claim 12 wherein the first guide rail has a first centerline and the second guide rail has a second centerline and the first centerline is offset from the second centerline by a distance O.

18. The method of claim 16 wherein an overall height of the first strip is H from a backing to a cap and the depth of the first channel is D, and H is greater than D.
